(19) United States
(12) Patent Application Publication
(10) Pub. No.: US 2002/0165646 A1
(43) Pub. Date: Nov. 7, 2002

(54) Detection of movement parameters pertaining to a motor vehicle by means of a d-gps system

(76) Inventors: Bernd Bohr, Stuttgart (DE); Stefan Mischo, Schwieberdingen (DE)

Correspondence Address: KENYON & KENYON, ONE BROADWAY, NEW YORK, NY, 10004, US

(21) Appl. No.: 10/019,357

(22) PCT Filed: Jan. 17, 2001
(86) PCT No.: PCT/DE01/00174

(30) Foreign Application Priority Data
Feb. 24, 2000 (DE) 100 08 550.4

(51) Int. Cl. G01C 21/26

(52) U.S. Cl. 701/1; 701/213

(57) ABSTRACT

The present invention proposes a method and a device for determining a motion parameter of a motor vehicle, a control system (1) for determining, in particular, the instantaneous velocity vector and the angle between the longitudinal vehicle axis and the velocity vector (float angle) is calculated, making use of a differential navigation system (D-GPS) [sic]. Since the differential navigation system (D-GPS) provides considerably more accurate positional data than a ‘normal’ navigation system used in motor vehicles, the determination of the velocity vector of the motor vehicle can also be carried out with greater accuracy. This is relevant, in particular, on a slick roadway when the motor vehicle goes into a skid or when the measured data of the wheel sensor are no longer reliable. In a further embodiment of the present invention, provision is made for the data provided by the navigation system to be also used for checking and monitoring the sensor data. A warning message can be output when a predefined limiting value is exceeded.

### BACKGROUND INFORMATION

The present invention is based on a method for determining a motion parameter of a motor vehicle according to the species defined in the main claim. A vehicle device for evaluating positional signals received from at least one transmitter is already known from German Patent Application DE 195 28 183 A1. In this vehicle device, for instance, time signals are received from the GPS satellite system and used to compute therefrom the positional data for diverse motion parameters of the vehicle such as the traveling speed, acceleration, changes in angles of rotation and of direction. These motion parameters are used to control devices for the vehicle or for the engine. It is possible, for example, to control an ABS anti-lock braking system or a vehicle-speed limiter from the determined velocity signal.

It appears to be unfavorable, however, that the calculation of the vehicle's position from the signals of the satellite system is relatively imprecise so that the motion parameters determined therefrom can show a considerable fault-tolerance. In particular, angles of rotation about the vertical axis cannot be calculated with sufficient accuracy. However, this is required when the vehicle begins to go into a skid, in particular, in the case of a slippery and slick roadway. Because a suitable open-loop or closed-loop control can only prevent the vehicle from breaking away if an angle of rotation, in particular the float angle (angle between the longitudinal vehicle axis and the velocity vector of the vehicle), is detected early.

Moreover, fundamental considerations on the control of the yaw velocity as a function of the steering angle and of the traveling speed, making allowance for the vehicle float angle, are known from the publication ‘FDR—Die Fahrdynamikregelung von Bosch’ [VDC—The Vehicle Dynamics Control System of Bosch], Anton van Zanten, Rainer Erhardt and Georg Pfaff, ATZ—Automobiltechnische Zeitschrift [Automotive Engineering Magazine] 96 (1994) 11, pages 674 through 689. In this publication, theoretical connections between the actual behavior of a motor vehicle, making allowance for the yaw velocity and the float angle, are initially depicted and subsequently explained in greater detail on the basis of a control unit. To determine the steering angle, the vehicular speed and the yaw speed during cornering, corresponding sensors are used which are located on the vehicle. However, no information on the use of positional signals which are transmitted by a satellite system can be gathered from this publication.

### ADVANTAGES OF THE INVENTION

The method and device according to the present invention for determining a motion parameter of a motor vehicle, having the characterizing features of independent claims 1 and 6 have the advantage over the background art that the instantaneous velocity vector can be determined very accurately for the motor vehicle with its exact position in the global coordinate system by using the differential positioning satellite system, preferably the D-GPS system. The determination of the velocity vector from signals from wheel sensors is too unreliable since, for instance in the case of a slick roadway, the wheel speed is corrupted as a result of a brake intervention. Here, a position and speed calculation from the signals of the D-GPS system helps in an advantageous manner. It has turned out in practice that a position determination via a D-GPS system is possible with an accuracy to less than one meter. This is a considerable improvement over the known GPS system (global positioning system) in which tolerances of 100 m or more are possible.

Advantageous refinements and improvements of the method indicated in the main claim and of the device are made possible by the measures specified in the dependent claims. It is particularly advantageous that the calculation of the float angle and/or of the velocity vector is used for controlling the yaw speed of the motor vehicle. In particular, it is possible for an appropriate device for vehicle dynamics control (VDC) to compensate for the yaw speed and thus effectively prevent the vehicle from floating and getting out of control, given an early intervention, for example, by braking the relevant wheel.

It is also regarded as a special advantage that the motion parameters determined by the D-GPS system can be used for checking or also for correcting the data of the vehicle sensors. This is carried out especially in phases when, for instance, the vehicle travels on a straight path during normal driving. The data of a yaw-rate sensor can be acquired, for example, during normal cornering.

It is considered to be particularly advantageous that a warning message is output to the driver when a predetermined threshold for the difference from the satellite signals and the sensor signals determined parameter values is exceeded. On the basis of the warning, the driver recognizes that, for instance, the device for vehicle dynamics control is defective. He/she is thus able to visit a service station in good time to have his/her vehicle checked.

### DRAWING

An exemplary embodiment of the present invention is depicted in the drawing and will be explained in greater detail in the following description.

FIG. 1 shows a block diagram,

FIGS. 2 and 3 depict diagrams in a global coordinate system,

FIG. 4 shows a third diagram, and

FIG. 5 shows a table.

### DESCRIPTION OF THE EXEMPLARY EMBODIMENT

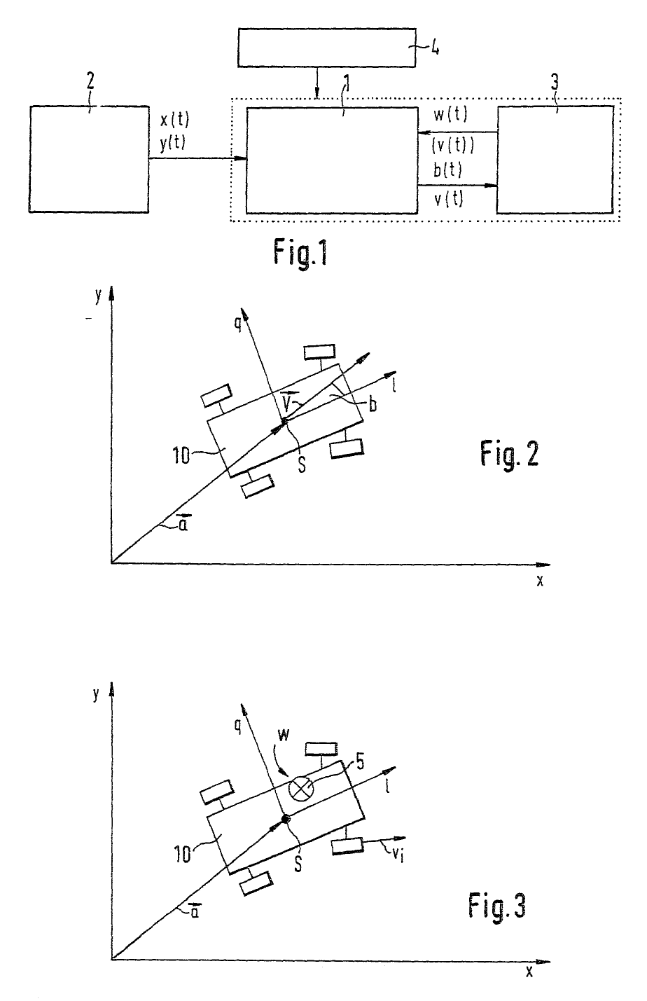

The block diagram of FIG. 1 shows a control system 1 which is connected via a corresponding input to a navigation system 2 which is designed as a differential navigation system (D-GPS, Global Positioning System). D-GPS system 2 supplies time-dependent data for the determination of the position of a motor vehicle in a global coordinate system x(t), y(t). Connected to control system 1 is, moreover, a sensor 4 which, for example as a wheel-speed sensor, measures the speed of the vehicle. Provision can be made for further sensors such as steering-angle, rate-of-rotation, transversal-acceleration and/or suspension-travel spring travel sensors. On the output side, control system 1 is connected to a control unit 3 which is used, for example, for vehicle dynamics control (VDC, ESP). In an alternative embodiment of the present invention, provision is made for control unit 3 to be connected to sensor 4 and to supply the data thereof to control system 1, preferably in broken down form. This can be data on the vehicular speed v(t) or on the steering angle w(t). On the other hand, control system 1 provides preprocessed data on the vehicle's actual speed or on float angle b(t). The float angle is to be understood as the angle which is formed between longitudinal vehicle axis 1 and velocity vector V. This interrelationship is further illustrated in FIG. 2.

The diagram of FIG. 2 shows a global x, y-coordinate system in which the motion of vehicle 10 is described by three state variables. The position of the vehicle's center of gravity S can accordingly be described by vector a. Velocity vector V acts upon the vehicle's center of gravity S and shows in the moving direction of the vehicle. Float angle b(t) between longitudinal vehicle axis 1 and velocity vector V is to be mentioned as the third variable. The D-GPS receiver should preferably be arranged in the vicinity of center of gravity S. In practice, this will not always be possible. Therefore, a corresponding offset value must be allowed for in the position determination for correction.

FIG. 3 shows the measured variables which for determining the vehicle state variables, in particular the position of the vehicle's center of gravity S which is determined from data of D-GPS system 2, rate of rotation w of motor vehicle 10 which rate is supplied by sensor 4, for example, a rate-or-rotation or yaw rate sensor 5. Alternatively, this information can also be provided by a suitable control unit 3 for vehicle dynamics control. Moreover, the wheel velocity or wheel speed is supplied preferably by a wheel-speed sensor for compensation and augmentation tasks. Rate-of-rotation sensor 5 indicates rate of rotation w or the angle of rotation as a function of the traveling speed or of the distance traveled.

Alternatively, a suitable steering angle sensor can be used as well.

The component of the vehicular speed in l-direction is estimated as a further parameter. This component is calculated from a reference speed which is supplied by control unit 3 from the data of the wheel-speed sensor and, possibly, further data, for example, from engine management data. This parameter is dealt with as a measured variable and will be explained in greater detail in the following.

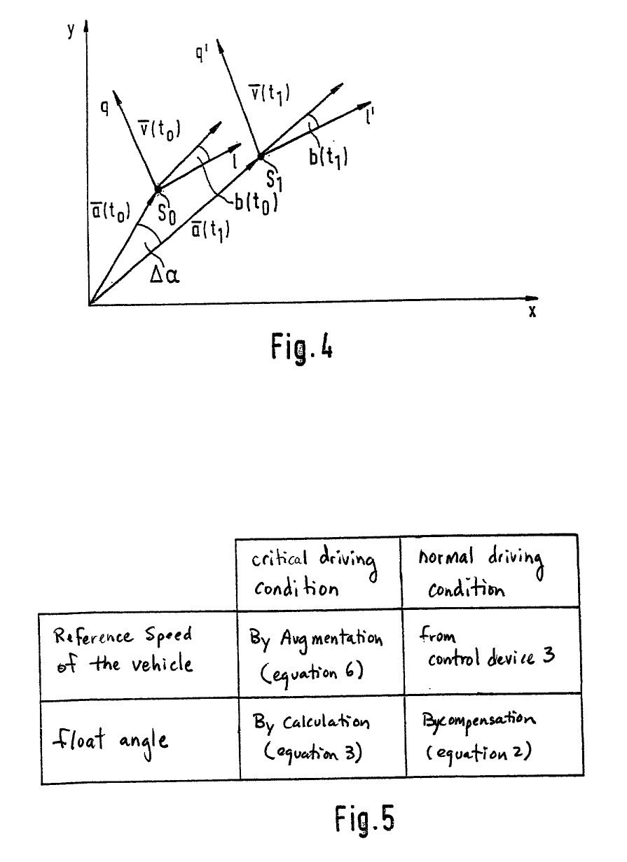

The movement of vehicle 10 from an instant t₀ to instant t₁ will be explained in greater detail with reference to FIG. 4. The x/y-coordinate system shows the position of center of gravity S₀ at instant t₀ and S₁ at instant t₁, including the corresponding velocity vectors.

\overline{v}(t₀) and \overline{v}(t₁)

as well as float angles b(t₀) and b(t₁). During this period, the position of the center of gravity changes from S₀ to S₁, the position being described by the vectors a(t₀) and a(t₁), respectively, and angular change Δα. The vehicle axes change accordingly from l, q to l′, q′.

The equations for the speed of the vehicle's center of gravity S can now be derived from this coordinate representation as follows. The time derivation of the position vector supplied by the D-GPS system yields the velocity vector for vehicle 10

$$\vec{v} = \frac{\partial \vec{a}}{\partial t} \qquad ( equation 1 )$$

With that, it is possible to calculate float angle b via the equation

$$cos b = \frac{{v}_{1}}{\vert \vec{v} \vert} \qquad ( equation 2 )$$

Since in some situations, for example in the case of black ice, the reference speed supplied by control unit 3 is not reliable, float angle b can be calculated according to FIG. 4 as follows. The vehicle starts with a float angle of b=0°. The change in the float angle Δb over time can be determined via the following equation:

Δb=b(t1)−b(t₀)=Δγ−Δα (equation 3)

where

$$Δγ = {\int }_{{t}_{0}}^{{t}_{1}} ω ( τ ) ⅆ τ \qquad ( equation 4 )$$

as integration of rate-of-rotation signal w of the rate-of-rotation sensor, and

Δα=α(t₁)−(t₀)

where

$$tan α ( {t}_{i} ) = \frac{y ( {t}_{i} )}{x ( {t}_{i} )} \qquad ( equation 5 )$$

The calculation in equation 2 can be used for compensating Δγ in equation 3 during uncritical driving conditions since the signal of the rate-of-rotation sensor generally includes an offset which would accumulate further and further through the integral in equation 4.

Thus, an augmentation of the reference speed of the vehicle via the equation

vl=|\overline{v}|cos b (equation 6)

can be only carried out when a critical driving condition prevails, which indeed is only necessary in this case. The individual conditions for a critical driving condition are given by the sensor and tire tolerance compensation and already allowed for in control unit 3.

Table 5 summarizes the connection between the reference speed of the vehicle and the float angle in a critical and in a normal driving condition.

With reference to the exemplary embodiment of FIG. 1, D-GPS system 2 delivers time-variable coordinates x(t) und y(t) in the global coordinate system to control system 1. The control system receives instantaneous rate of rotation w(t) from sensor 4 as well as reference speed v(t). These values can also be supplied by a suitable control unit 3. Control system 1 calculates from these values instantaneous float angle b(t) and the new reference speed v*(t) which are available to control unit 3 for further use. If control unit 3 is designed as a vehicle dynamics controller (VDC, ESP), then it is possible for these values to be used, in particular, for correcting instantaneous float angle b(t), i.e., for stabilizing the momentary driving condition of motor vehicle 10.

In an alternative embodiment of the present invention, provision is made for the data supplied by the navigation system for position determination to be also used for checking the parameters supplied by sensor 4 or control unit 3. Thus, if the vehicle's position is repeatedly determined on the basis of the navigation data, the distance traveled by the vehicle which was ascertained by sensor 4 or control unit 3 can be compared with the data supplied by the satellite system. The equivalent applies to the traveling speed and to the angle determinations from the values of the rate-of-rotation sensor. If the difference which was ascertained from the satellite data and the sensor data exceeds a predefined threshold value, this can suggest an error. In this case, preferably, a message is issued to the driver so that the driver can take his/her vehicle to a workshop for inspection.

What is claimed is:

1. A method for determining a motion parameter of a motor vehicle (10), at least one sensor (4), for example a speed sensor, a steering-angle sensor, a rate-of-rotation sensor, a transversal-acceleration sensor, a suspension-travel sensor, and/or a satellite system, transmitting data to a control system (1) of the motor vehicle (10), the control system calculating the velocity vector and its position from the received data according to a predefined algorithm,
wherein the navigation system is a differential positioning satellite system (D-GPS system) which transmits data to the control system (1); and the control system (1) calculates the exact position coordinates for the vehicle's center of gravity in the global coordinate system, the instantaneous velocity vector, and/or its float angle from the received data of the at least one sensor (4) and of the D-GPS system (2).

2. The method as recited in claim 1,
wherein the control system (1) uses the float angle and/or the velocity vector for controlling the yaw velocity of the motor vehicle (10).

3. The method as recited in claim 1 or 2,
wherein the velocity vector and/or the float angle β(t) used in a device (3) for vehicle dynamics control (VDC, ESP).

4. The method as recited in one of the preceding claims,
wherein the control system (1) calculates the motion parameters from repeatedly received signals of the D-GPS system and compares them to the calculated data which were supplied by the at least one sensor (4).

5. The method as recited in claim 4,
wherein the control system (1) outputs a warning message to the driver when a predefined threshold value for the difference of the parameter values calculated from the satellite signals and the sensor data is exceeded.

6. A device for carrying out the method according to one of the preceding claims,
wherein the device features a control system (1) which receives data from a sensor (4) and/or a control unit (3) and from a differential positioning satellite system (D-GPS system, 2), and
the control system (1) is designed so as to calculate the instantaneous velocity vector and/or the float angle from the received data.
